(19) United States
(12) Patent Application Publication
(10) Pub. No.: US 2026/0051010 A1
(43) Pub. Date: Feb. 19, 2026

(54) SYSTEM

(71) Applicant: SOFTBANK GROUP CORP., Tokyo (JP)

(72) Inventor: Reio KONISHI, Tokyo (JP)

(73) Assignee: SOFTBANK GROUP CORP., Tokyo (JP)

(21) Appl. No.: 19/299,443

(22) Filed: Aug. 14, 2025

(30) Foreign Application Priority Data
Aug. 16, 2024 (JP) 2024-137112

(51) Int. Cl. G06Q 50/26

(52) U.S. Cl. CPC G06Q 50/265

(57) ABSTRACT

A system includes a processor that is configured collect pre-disaster communication environment data and mobile population data, estimate the number of evacuees at each evacuation shelter by using an artificial intelligence model based on the collected data, calculate the amount of needed relief supplies based on the estimation result, to instruct preparation and delivery of the supplies, and, after communication recovery, collect on-site situation data, update the data, recalculate the required supplies, and instruct additional delivery of supplies.

### CROSS-REFERENCE TO RELATED APPLICATION

This application is based on and claims priority under 35 USC 119 from Japanese Patent Application No. 2024-137112 filed on Aug. 16, 2024, which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In the event of a large-scale disaster such as an earthquake, it is extremely challenging for authorities and relief organizations to promptly and accurately understand the situation at evacuation shelters and to ensure the efficient supply of necessary relief goods. Existing systems often rely on manual data collection and estimation, resulting in delivery delays, misallocation of resources, and insufficient or excessive provision of supplies. Furthermore, rapid changes in the number of evacuees and communication disruptions during disasters make it difficult to determine the real-time needs of each shelter.

### SUMMARY

The present invention addresses these problems by providing a system equipped with a processor configured to collect pre-disaster communication environment data and mobile population data, to estimate the number of evacuees at each evacuation shelter using an artificial intelligence model based on the collected data, to calculate the required amount of relief supplies and instruct their preparation and delivery, and, after communication recovery, to collect updated on-site information, recalculate the necessary supplies, and instruct any additional delivery as needed. The artificial intelligence model is trained using past disaster data, and the calculation of necessary supplies includes specific relief goods such as water, food, medicine, and blankets, enabling rapid and accurate response to dynamic disaster situations.

“Processor” means a computing unit capable of executing instructions, processing data, and controlling various operations within the system.

“Communication environment data” means information related to the availability, stability, and condition of telecommunications infrastructure and network connectivity in a given area.

“Mobile population data” means statistical and real-time information regarding the movement and distribution of people in specific regions, typically obtained from mobile network operators or related sensors.

“Artificial intelligence model” means a software-based model, such as a neural network or other machine learning algorithm, trained to perform prediction or estimation tasks based on complex datasets.

“Evacuation shelter” means a temporary place designated for people to stay and ensure their safety during and after a disaster event.

“Estimation” means the process of calculating or predicting a value or quantity, such as the number of evacuees, based on available data and computational models.

“Relief supplies” means essential items required for the basic needs and survival of evacuees during a disaster, including but not limited to water, food, medicine, and blankets.

“Preparation and delivery” means the activities involved in organizing, assembling, and transporting relief supplies from storage or warehouses to evacuation shelters.

“On-site situation data” means up-to-date information gathered from evacuation shelters regarding the current number of evacuees, condition of supplies, and any other immediate needs.

“Communication recovery” means the restoration of telecommunications infrastructure and services following a disruption caused by a disaster.

“Additional delivery” means subsequent supply shipments instructed or carried out in response to updated needs at evacuation shelters after initial deliveries have been made.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

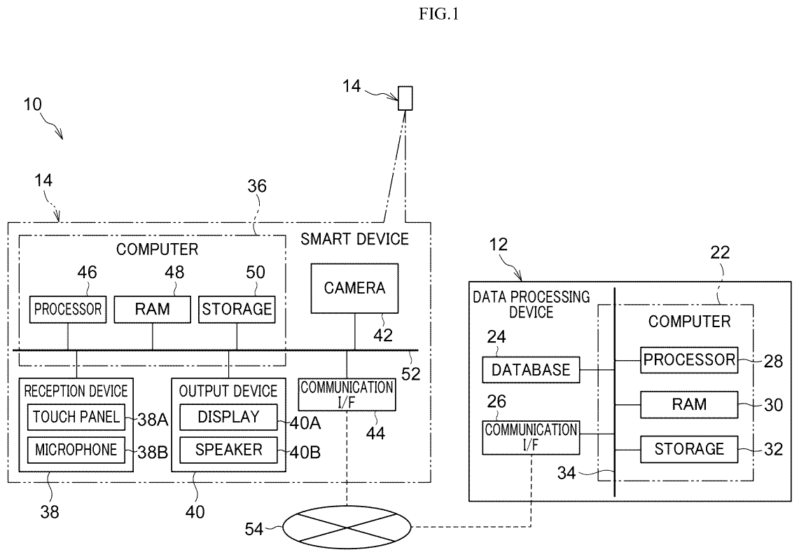

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

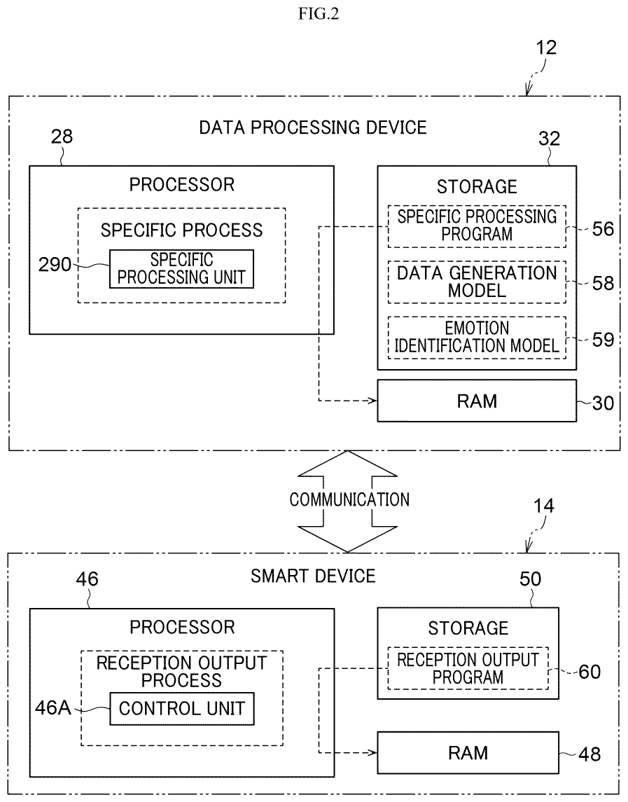

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the event of a disaster, it is difficult to rapidly and accurately grasp the situations at evacuation sites and to supply necessary support goods effectively. Particularly, when there are significant fluctuations in population flow or communication environments, or when it is difficult to predict the number of evacuees, conventional resource allocation and supply plans often fail to reflect the actual needs, leading to shortages, delays, or excessive distribution of support goods. Additionally, existing systems lack the ability to process complex multi-source data in real-time and optimize the prediction and delivery of support goods dynamically.

The specific processing by the specific processing unit 290 of the data processing device 12 in Example 1 is realized by the following means.

The present invention provides a server including a processor configured to acquire mobile entity information and communication state information from multiple information providing devices, perform statistical normalization of the data for generative artificial intelligence model input, construct prompt sentences to predict evacuee numbers at each evacuation site, calculate and update the required quantities of various support goods based on real-time and updated data, verify stock status with storage devices, and automatically generate and instruct delivery plans in coordination with logistics information processing devices. This enables rapid, accurate, and optimized supply of support goods to evacuation sites by utilizing predictions adjusted to real-time ground situations and by dynamically updating delivery plans according to changing conditions and user inputs at the evacuation sites.

The term “mobile entity information” refers to data representing the movement, location, and quantity of individuals or groups within a specified geographic area, typically obtained from sources such as mobile communication devices or population monitoring systems.

The term “communication state information” refers to data related to the operational status, quality, and congestion level of communication networks in a target area, including metrics such as utilization rate, bandwidth availability, and connection stability.

The term “information providing device” refers to any apparatus, system, or network component capable of supplying data relevant to population movement or communication environment, such as telecommunications equipment, data servers, or network infrastructure. The term “statistical computation” refers to the process of applying mathematical operations, such as averaging, standardizing, or normalizing data, in order to prepare or enhance data for subsequent analysis or input into computational models.

The term “generative artificial intelligence model” refers to a software-based machine learning framework that can generate predictions, estimates, or synthesized information based on provided input data, and which is typically trained with relevant historical data.

The term “prompt sentence” refers to a structured textual input or instruction formulated for presentation to a generative artificial intelligence model in order to elicit a desired predictive or analytical output.

The term “evacuation site” refers to a designated facility, building, or location intended to receive and accommodate persons seeking shelter during or after a disaster event.

The term “support goods” refers to essential items and resources necessary for the well-being and survival of evacuees, including but not limited to liquid necessities, food products, pharmaceuticals, and bedding.

The term “support goods information storage device” refers to a computing apparatus or database system that records and manages inventory data regarding available support goods, their quantities, and their locations.

The term “logistics information processing device” refers to a computing system, server, or software platform used for managing, scheduling, and optimizing the transportation and delivery of goods from storage facilities to designated sites.

The term “on-site device” refers to any user-operated electronic apparatus, such as a mobile terminal, smartphone, or tablet, used at an evacuation site for inputting or transmitting local status updates and situational information.

The term “information storage device” refers to any data storage apparatus, system, or database that holds information regarding evacuation sites, support goods, or real-time updates, and is accessible by the processor for analysis and decision-making.

The term “real-time data” refers to information that is collected, processed, and made available with minimal delay, enabling timely and responsive system operations during dynamic events or emergencies.

The term “delivery plan” refers to a structured schedule or set of instructions for the transportation and distribution of support goods from storage facilities to evacuation sites, including routing, timing, and quantity details.

The term “additional delivery” refers to any subsequent or supplemental transportation of support goods arranged and executed in response to updated needs or changing circumstances at an evacuation site.

The server first receives mobile entity information and communication state information from various information providing devices. These devices may include communication network infrastructure, data aggregators, or other systems capable of supplying population statistics and communication data. The server then performs statistical computations, including normalization and standardization, on the acquired data. Such data preprocessing may utilize standard software libraries like pandas and NumPy, running on a general-purpose computer system.

After data preparation, the server constructs a prompt sentence based on the standardized information and provides it as input to the generative artificial intelligence model. An example of such a prompt sentence is:
“Given the following data:
   Location: Shelter A
   Standardized floating population: 1.2
   Standardized communication utilization: 0.7
Predict the most likely number of evacuees at Shelter A.”

The server, using the AI model, generates a prediction for the number of evacuees at each evacuation site.

Based on the predicted number of evacuees, the server calculates the required quantities for each category of support goods, such as liquid necessities, food items, pharmaceuticals, and bedding. The calculation logic resides in a dedicated software module implemented on the same server. The server then checks inventory data for support goods by querying the support goods information storage device, ensuring that the system can accurately identify available stock at storage facilities.

For delivery planning, the server communicates with a logistics information processing device, which may include dedicated software or APIs for transportation scheduling and route optimization, such as those provided by a logistics management service. The server automatically generates delivery instructions according to the calculated requirements and current inventory status.

Users, such as shelter administrators, operate on-site devices to record and input real-time information concerning evacuees and support goods status at the evacuation site. For example, a user may enter:
“Current evacuee count: 600. Water supplies are insufficient.”

Such data are transmitted via the terminal's communication interface to the server, which updates the records stored in the information storage device.

Upon receiving updated data, the server repeats the process of recalculating predicted needs using the generative artificial intelligence model, calculating additional demands, and revising delivery instructions accordingly. In this manner, the system enables dynamic, real-time adjustment and optimization in the supply of support goods during disaster response operations, ensuring that each evacuation site receives adequate resources based on the latest available information.

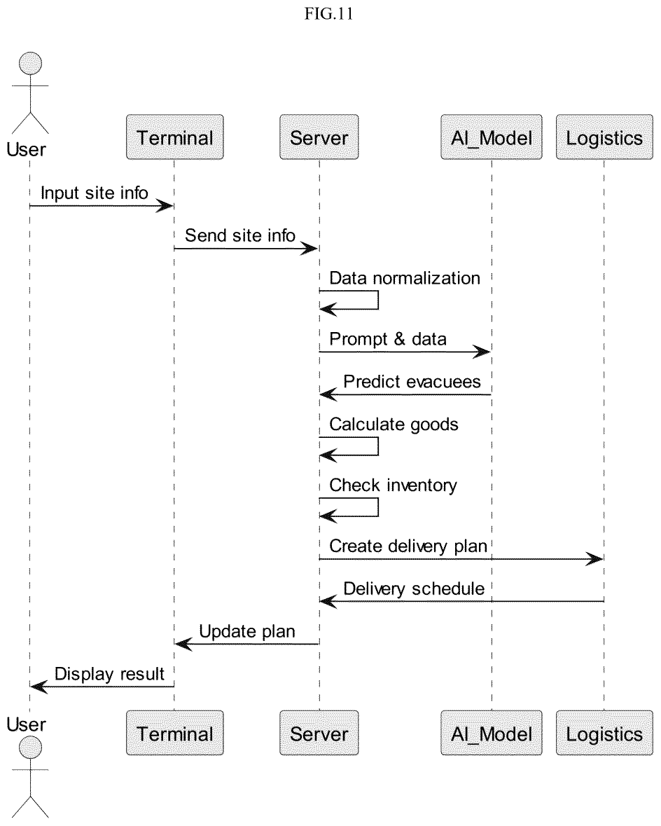

The following describes the processing flow using FIG. 11.

### Step 1:

The server receives mobile entity information and communication state information as input from information providing devices via secure API calls. The server extracts relevant fields from the received JSON data, such as the number of individuals in a specific area and the percentage of network utilization, and stores them in the information storage device as structured records. The output is a set of pre-processed, time-stamped demographic and communication records saved in a database.

### Step 2:

The server retrieves the newly stored records as input and performs data processing including normalization and statistical standardization. The server calculates z-scores for each data point using historical means and standard deviations retrieved from the database. The output is a set of standardized data arrays suitable for AI model processing.

### Step 3:

The server uses the standardized data as input and constructs a prompt sentence for the generative AI model. The server formats the input data into a natural language prompt, such as:

“Given the following data: Location: Shelter A, Standardized floating population: 1.2, Standardized communication utilization: 0.7, predict the most likely number of evacuees at Shelter A.”

The output is a formatted prompt sentence and the corresponding data vector prepared for AI model prediction.

### Step 4:

The server inputs the prompt sentence and data vector into the generative AI model. The server executes the prediction process and receives as output the predicted number of evacuees for each evacuation site. The output is a numeric evacuee prediction for each site.

### Step 5:

The server uses the predicted number of evacuees as input for a calculation module. The server multiplies standard coefficients of support goods per person (such as amount of water, food, pharmaceuticals, and bedding) by the predicted evacuee number, generating a list of required support goods quantities. The output is a structured list of support goods required at each evacuation site.

### Step 6:

The server queries the support goods information storage device using the list of required support goods as input. The server performs inventory lookups to compare required quantities with the available stock at storage facilities. The output is a summary of available stock versus required amounts for each item at each facility.

### Step 7:

The server assembles the inventory and demand data as input for delivery planning. The server communicates with the logistics information processing device via API, specifying the necessary goods, source storage locations, and destination evacuation sites. The server applies a route optimization algorithm and receives as output a delivery plan, including schedules, source-destination pairs, and vehicle assignments.

### Step 8:

The user, acting as a shelter administrator, inputs current on-site information regarding evacuees and support goods status using a terminal such as a smartphone or tablet. The input includes the number of evacuees and any shortages or urgent needs. The output is a new record containing real-time site status, which is transmitted to the server.

### Step 9:

The terminal receives the user's inputs, formats them into structured data, and transmits them via secure communication protocols to the server. The input consists of user-provided numerical and categorical data. The output is successful delivery of site status updates to the server.

### Step 10:

The server receives the updated site status as input, updates the information storage device, and triggers a recalculation of support goods requirements. The server repeats the cycle of prediction, calculation, stock verification, and delivery planning based on the updated input. The output is an updated support goods and delivery plan that reflects the most recent shelter needs.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In disaster situations such as earthquakes, it is extremely difficult to accurately and rapidly assess the status of evacuation facilities and supply the necessary livelihood support materials due to disrupted communication environments, rapidly changing population flows, and inadequate cooperation with logistics providers. Additionally, traditional approaches fail to dynamically allocate resources or provide psychological support based on the emotional states of evacuees in real time, often resulting in shortages, supply delays, and insufficient emotional care for affected individuals.

The specific processing by the specific processing unit 290 of the data processing device 12 in Application Example 1 is realized by the following means.

The present invention provides a server including processing means configured to collect demographic trend data and communication infrastructure data from external sources, preprocess and analyze such data using a generative information processing device to estimate the number of users of evacuation facilities, automatically calculate and optimize the allocation and delivery of livelihood support materials based on real-time information and updated field input, estimate the emotional states of evacuees using an emotional identification processing device, and provide instructions for psychological support and entertainment resources as needed. This enables efficient, responsive, and accurate management of material supply and psychological support for evacuation facilities even under conditions of disrupted communication and rapidly changing user needs in disaster scenarios.

The term “demographic trend information” refers to electronically collected data expressing population movements, distributions, or changes over time within a specific region.

The term “communication infrastructure information” refers to data indicating the status, functionality, or utilization levels of communication networks and related hardware or software resources within a given area.

The term “external information providing device” refers to a data source or system, such as a remote server or database, capable of furnishing demographic or infrastructural data to another computerized system.

The term “preprocessing” refers to the steps of cleaning, normalizing, formatting, and organizing raw data to facilitate subsequent analysis, modeling, or inference by automated systems.

The term “generative information processing device” refers to a computing system or module capable of performing predictions or inferences on the basis of input data, typically using a generative AI model, to estimate situation-dependent parameters such as user numbers.

The term “evacuation facilities” refers to any designated shelter, site, or structure prepared to temporarily accommodate displaced persons during emergency or disaster situations.

The term “livelihood support materials” refers to items required for the maintenance of basic living standards and welfare in evacuation environments, including but not limited to potable water, consumable food, health maintenance goods, sleeping support goods, and consumable welfare aid goods.

The term “inventory information” refers to records or databases indicating current stock levels, locations, and availability of livelihood support materials.

The term “transportation entity” refers to any organization, contractor, or means used for the movement and delivery of goods from storage locations to evacuation facilities.

The term “field management input device” refers to a user-operable electronic device at the evacuation facility, such as a mobile terminal, used to input and transmit situational or inventory data.

The term “information storage device” refers to a hardware or software component, such as a memory unit or database, for recording, updating, and retrieving data relevant to evacuation management.

The term “emotional identification information processing device” refers to a computational module, potentially AI-based, for analyzing input data such as images, voice, or text to determine the emotional state of individuals or groups.

The term “psychological support measures” refers to actions, services, or delivered items (such as counseling support or recreational resources) intended to improve or stabilize the emotional or psychological well-being of evacuees.

The term “entertainment materials” refers to tangible or digital items, such as games, books, audiovisual media, or other resources, provided to improve morale and reduce stress among evacuees.

The term “response status” refers to data indicating the current progress, completion, or pending actions of deliveries, support measures, or updates within the system.

The term “management input device” refers to an electronic interface operated by authorized personnel used to receive system notifications, status updates, or enter management-related commands.

The term “inference algorithm” refers to a computational procedure used by the generative information processing device to perform predictions based on input data.

An embodiment for implementing the invention is described as follows:

The system includes a server equipped with advanced information processing hardware such as a high-performance computing device or cloud-based infrastructure, and software modules including application programming interfaces (APIs), data cleaning and analytics tools, and generative AI models. Typical server platforms may include general-purpose database servers, cloud computing environments, and dedicated storage resources. Terminal devices, which may include smartphones, tablets, or other portable electronic devices, are used by field operators or shelter administrators to input live data and receive real-time notifications. Users, primarily evacuation facility managers, interact with the system through intuitive inputs on these terminals.

The server is programmed to electronically collect demographic trend information and communication infrastructure data from external information sources, such as network providers or official public databases, utilizing APIs and automated data retrieval tools. Exemplary software components include the use of Python's requests library for API calls, pandas and numpy for data preprocessing, and database engines such as MySQL or PostgreSQL for data storage and organization.

Once collected, data is preprocessed by the server to ensure quality and consistency. This process includes cleaning raw entries, handling missing values, standardizing formats, and converting all time-stamped data into a unified structure. The preprocessed data is input into a generative information processing device. In a preferred embodiment, the server employs generative AI models based on machine learning frameworks, such as TensorFlow or PyTorch, to infer the estimated number of users at evacuation facilities. These models may be dynamically optimized by additional learning from past disaster records and time-series event data.

Based on the inferred user numbers, the server automatically calculates the required amount of livelihood support materials, which include but are not limited to potable water, consumable food, health and hygiene goods, sleeping aids, and welfare support items. The server checks available inventory data, optimizes delivery plans using, for example, optimization libraries or algorithms (such as Google OR-Tools), and electronically issues delivery instructions to transportation entities via secure network protocols like HTTPS. Delivery instructions are sent in a format compatible with logistics partner APIs or system interfaces.

The system further incorporates mechanisms for emotional state estimation. Through the terminal's built-in camera, microphone, or text entry, shelter administrators capture and submit data (such as images, voice recordings, or messages) representing the current emotional state of facility users. This data is sent securely from the terminal to an emotional identification information processing module, which may reside in the cloud or on the central server. This module analyzes the input using AI-driven emotion recognition algorithms (for example, an emotion analysis API or a custom trained neural network). If elevated stress or other significant emotional states are detected, the server automatically issues psychological support measures or directs the delivery of entertainment materials, such as games or books, to the affected facility.

Notifications and updated supply or support statuses are delivered from the server to the terminal devices, ensuring that users are always aware of current resource levels, pending deliveries, and support actions undertaken.

A specific example of system usage is as follows: The server periodically collects demographic and communication data via external APIs, pre-processes this information, and provides input to a generative AI model which forecasts current evacuee numbers for several shelters. One shelter manager, upon noting an increase in evacuee numbers and a shortage of water, uses a tablet to report this data. The terminal transmits the updated figures to the server in real time. The server receives this input and recalculates the materials required, checks warehouse inventories, and issues additional delivery instructions to the logistics provider. Simultaneously, the server notifies the shelter manager of expected delivery times. If emotional analysis of reported images detects group stress, the server sends further support resources such as mental health professionals or entertainment kits.

Examples of prompt sentences for generative AI model integration in this system include:
“Generate a Python workflow to preprocess population and communication data for input into a generative AI model that predicts shelter occupancy.”
“Create delivery instructions from warehouse data and forecasted evacuee numbers for use by a logistics partner's API.”
“Analyze uploaded images and voice recordings to infer the emotional state of shelter users and recommend appropriate psychological support actions.”
“Write a procedure to integrate real-time field data input via mobile devices into a resource allocation and delivery optimization pipeline during emergency situations.”

By using standard hardware such as generic server architectures and portable terminal devices, with general-purpose software and AI analytics platforms, the invention ensures seamless, responsive, and adaptive management of resource allocation and emotional care in disaster evacuation scenarios.

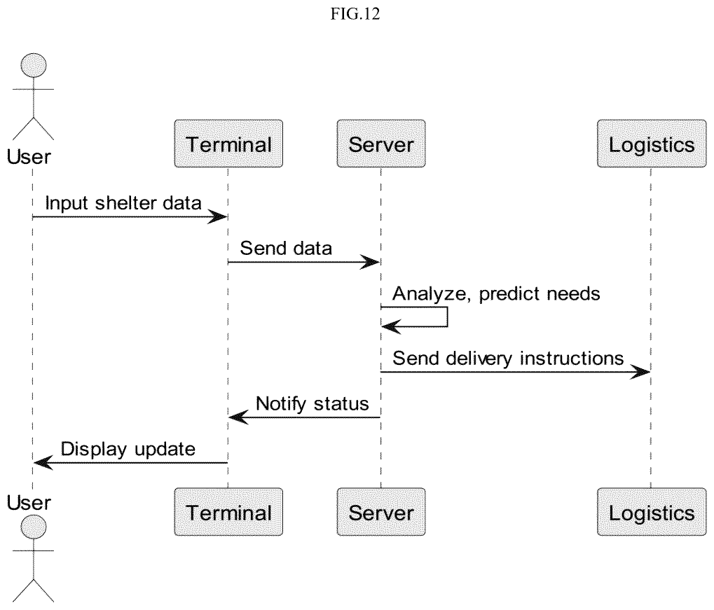

The following describes the processing flow using FIG. 12.

### Step 1:

Server collects demographic trend data and communication infrastructure data from external information sources through APIs. The server uses software such as the requests library to send authentication requests and fetch JSON-formatted datasets at regular intervals. Input: API endpoints and credentials. Data processing: Server makes HTTP requests and receives population movement logs and network status information. Output: Raw demographic and infrastructure data saved in storage.

### Step 2:

Server preprocesses the collected data to ensure consistency and quality for further analysis. The server loads the raw data using pandas, checks for missing fields, performs normalization (such as standardizing time zones and converting units), and removes outlier values. Input: Raw demographic and communication data. Data processing: Data cleaning, normalization, and outlier removal. Output: Cleaned and standardized data ready for AI analysis.

### Step 3:

Server inputs the preprocessed data into a generative AI model built with TensorFlow or a similar framework. The server executes the model's prediction function to estimate the number of evacuees for each evacuation facility. Input: Standardized demographic and communication data. Data processing: AI prediction using trained neural network parameters. Output: Predicted evacuee numbers for each facility.

### Step 4:

Server calculates the required amount of livelihood support materials based on the predicted evacuee numbers. The server applies predefined supply rules (for example, water, food, and blankets per person per day), assembles a supply list in structured format, and checks inventory databases for available stock. Input: Predicted evacuee numbers. Data processing: Supply calculation and inventory query. Output: Detailed supply requirements and available inventory report.

### Step 5:

Server optimizes the transportation schedule by referencing inventory locations and delivery routes. The server uses route optimization libraries or algorithms to match supply to need and schedules shipments with transportation entities. Input: Supply requirements and inventory locations. Data processing: Route optimization and delivery schedule creation. Output: Optimized delivery instructions for each transportation entity.

### Step 6:

Server sends delivery instructions to logistics partners via their system interfaces or APIs. The server forms structured payloads (including supply quantities, delivery addresses, and time windows), transmits them using secure protocols, and verifies successful transmission. Input: Optimized delivery instructions. Data processing: Formation and transmission of delivery requests. Output: Confirmation messages and delivery tracking data.

### Step 7:

User, serving as a shelter administrator, uses a terminal (such as a tablet or smartphone) to monitor supplies and enter real-time updates on evacuee counts and resource needs. User interacts with an app to fill out data forms, and the terminal generates structured JSON payloads. Input: Live observation of shelter conditions. Data processing: Manual entry and form validation by the terminal. Output: Real-time shelter status updates sent to the server.

### Step 8:

Server receives updated shelter information from the terminal, updates its central database, and determines whether additional support is required. The server runs the AI model if necessary, recalculates needs, and initiates new delivery instructions if shortages are detected. Input: Real-time shelter updates from terminals. Data processing: Database update, recalculation of supply needs, and additional delivery planning. Output: Updated delivery plans and new logistics instructions.

### Step 9:

Terminal provides functionality for the user to capture images, voice samples, or messages reflecting the emotional state of evacuees. The terminal encrypts and transmits this data to the emotional identification module on the server or in the cloud. Input: Captured media or text data from the shelter. Data processing: Data capture, encryption, and upload. Output: Emotional state data transmitted to the server.

### Step 10:

Server or an emotional identification module analyzes the received emotional data using AI-based emotion recognition algorithms. If high stress, anxiety, or other negative emotional states are detected, the server determines necessary psychological aid and support materials. Input: Emotional state data. Data processing: Emotion analysis, identification of support needs. Output: Instructions for psychological support deployment or entertainment material delivery.

### Step 11:

Server notifies the terminal and thus the user about current resource status, planned deliveries, and psychological support measures using automated notifications or app alerts. Input: Status changes and logistics updates. Data processing: Message composition in the server. Output: User notifications displayed on the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the event of a large-scale disaster, it is essential to rapidly and accurately determine the situation at evacuation areas, to efficiently calculate and supply necessary relief goods, and to provide appropriate psychological support to evacuees. Conventional systems are limited in their ability to gather real-time site-specific data, to recalculate resource needs based on dynamic on-site information, and to address mental health needs with precision. Moreover, existing solutions often lack seamless integration of communication network analysis, evacuation population prediction, logistics management, and emotional state analysis, resulting in delays and insufficient support for evacuees.

The specific processing by the specific processing unit 290 of the data processing device 12 in Example 2 is realized by the following means.

The present invention provides a server including a processor configured to acquire communication environment information and population dynamics information, normalize and complete the acquired data, estimate evacuee numbers using a computational intelligence model, calculate and instruct the delivery of auxiliary goods, receive and process on-site updates from user terminals, analyze emotional state data, and output information input sentences for generative intelligence models. This enables real-time, integrated management of evacuation operations, optimized supply of relief goods, and timely psychological support, thereby improving safety, comfort, and well-being for evacuees during disasters.

The term “communication environment information” refers to data related to the status, availability, performance, and quality of communication networks in a specific area, including factors such as network connectivity, signal strength, and data transmission speed.

The term “population dynamics information” refers to data indicating the movement, number, and distribution patterns of people within a designated region, typically obtained through analysis of location information from communication terminals or similar sources.

The term “normalization” refers to a process of converting collected raw data into a consistent, standardized format or scale, so as to ensure uniformity and comparability across different data sets.

The term “completion of missing data” refers to a procedure wherein absent or incomplete values in a data set are supplemented with estimated or interpolated values, thereby generating a complete and usable data set.

The term “computational intelligence model” refers to an algorithmic or machine learning system, such as a neural network, designed to derive predictions or analytical results from input data based on prior training.

The term “evacuation area” refers to a physical location or facility designated as a temporary refuge for individuals affected by a disaster, where support and resources are provided.

The term “auxiliary goods” refers to items and resources necessary to maintain minimum standards of living and comfort for evacuees, including but not limited to food, water, medical supplies, bedding, and recreational items.

The term “storage device for auxiliary goods” refers to a hardware or facility used for holding and managing inventory of auxiliary goods awaiting distribution.

The term “transport management device” refers to a hardware or system arranged to plan, coordinate, and control the delivery and distribution of goods.

The term “user terminal” refers to an electronic device, such as a smartphone or tablet, operated by an individual at an evacuation area to input and transmit situational or resource information.

The term “emotion estimation device” refers to a system or software module that analyzes multimodal data, such as expression, speech, or text, to determine the emotional or psychological state of a user.

The term “emotional state data” refers to analyzed or inferred information about a person's emotional or psychological condition, as generated by processing input from the emotion estimation device.

The term “psychological support measures” refers to interventions, actions, or resource allocations aimed at improving or maintaining the mental well-being of evacuees.

The term “generative intelligence model” refers to an artificial intelligence system capable of generating new content, responses, or suggestions based on input prompts and learned knowledge.

The term “information input sentence” refers to a textual prompt or instruction provided to a generative intelligence model, specifying the desired task, content, or scenario for generation. One embodiment of the invention will now be described in detail.

The system includes a server equipped with a processor, memory, communication interface, and data storage means. The server is networked with user terminals, storage facilities for auxiliary goods, transport management devices, and an emotion estimation device.

The server is configured to acquire communication environment information and population dynamics information in real time from communication network management devices and information processing devices. This is achieved through the use of application programming interfaces (APIs). For example, the server may access an API provided by a network operator or a service provider to receive real-time network status and population activity data in a given area. The server can be deployed using standard server hardware, operating on an operating system such as Linux or Windows Server, and using programming languages such as Python combined with libraries such as Pandas for data manipulation.

Upon receiving the data, the server performs normalization and completion of missing values. Normalization may include unit unification and reformatting, while missing data may be supplemented by interpolation or statistical methods, implemented with software tools such as Pandas or Numpy.

The normalized and completed data is provided as input to a computational intelligence model implemented on the server. This model may be realized as a neural network or other machine learning system, built using platforms such as TensorFlow or PyTorch. The model is trained using past disaster-related information and is capable of predicting the number of evacuees for each evacuation area.

Based on the estimated numbers of evacuees, the server calculates the required amount of auxiliary goods, such as drinking liquids, nutritional foods, health maintenance drugs, bedding, and recreational items. Calculation algorithms may use predefined consumption estimates per individual. The resulting list is cross-referenced with inventory records stored in a database, such as an SQL-based or cloud storage system.

The server interacts with transport management devices to generate and transmit delivery instructions for the calculated quantities of auxiliary goods. Communication with these devices may be achieved via RESTful APIs or other standardized messaging protocols.

Users, such as evacuation area administrators, interact with the system via user terminals, such as smartphones or tablets, which may run dedicated applications developed using frameworks like React Native or Flutter. Through the user terminal, the user can input real-time on-site data, such as the actual number of evacuees and the current status of auxiliary goods. Such data is transmitted to the server using secure protocols such as HTTPS.

Furthermore, the user terminal is configured to collect expression data, sound data, and character data from users or evacuees. This information can be obtained by taking photographs, recording voice clips, or entering text. The terminal then transmits this multimodal data to the emotion estimation device, which may be a dedicated software module running on a cloud service such as Microsoft Azure Cognitive Services or an equivalent. The emotion estimation device analyzes the input to generate emotional state data, for example, “high stress” or “neutral.”

Based on the analyzed emotional state data, the server determines whether psychological support measures or additional special goods are required and issues appropriate instructions for support delivery. Psychological support measures may include deployment of counselors, while special goods may include entertainment materials for stress relief.

Additionally, the server is configured to output an information input sentence specifying a content to be presented to a generative AI model. This input sentence, or prompt, may be automatically generated based on current system status and sent to an external generative AI platform to obtain contextually relevant outputs if needed for advanced operation simulations, reporting, or communications.

As a concrete example, the server may at 9:00 AM collect real-time population and network data, preprocess the data using Python and Pandas, input the results to a pre-trained neural network for headcount estimation, and cross-check the calculated requirements for food and water against the inventory database. A user at the evacuation area may report a sudden increase in the number of evacuees, prompting immediate recalculation and delivery instruction for extra goods. The user may use the terminal to capture and send photographs and voice messages, which the emotion estimation device interprets to detect high levels of stress, leading the server to dispatch additional psychological support resources.

An example of a prompt sentence for the generative AI model is as follows:

“Please simulate the operation of this emergency shelter management system, including the flow of real-time population data collection, AI-driven prediction of needed supplies, logistics planning, and emotional data analysis. Show step-by-step server- and terminal-side processing and concrete outputs.”

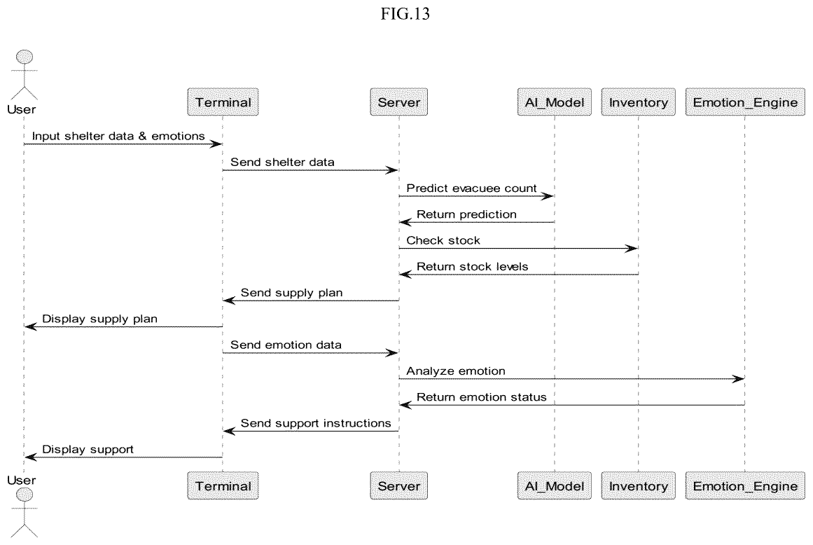

The following describes the processing flow using FIG. 13.

### Step 1:

The server acquires communication environment information and population dynamics information from external information processing devices via API requests. The input consists of API endpoint URLs and necessary authentication or parameter data, and the output is a set of raw data files containing real-time network status and population activity figures. This acquisition includes receiving JSON or CSV files with fields such as timestamp, location, network speed, and estimated headcount.

### Step 2:

The server normalizes the acquired data and completes any missing values. The input is the raw data from Step 1. The server processes the data using a data analysis library such as Pandas, converting all values to a unified format (such as standard time units and consistent measurement scales) and filling missing records through linear interpolation or statistical estimation. The output is a cleaned, fully populated data set ready for analysis.

### Step 3:

The server inputs the normalized data into a computational intelligence model implemented on a framework such as TensorFlow or PyTorch for population estimation. The input is the cleaned data set from Step 2. The server calls the prediction method of the machine learning model, which uses features such as area, time, and network conditions to estimate the number of evacuees at each evacuation area. The output is a table listing predicted evacuee numbers by location.

### Step 4:

The server calculates the required quantity of auxiliary goods based on the predicted number of evacuees. The input is the evacuation area headcount predictions from Step 3 combined with preset consumption rates for each type of auxiliary good. The server multiplies each item's per-capita requirement by the estimated population and compiles a list of total quantities needed per evacuation area. The output is an itemized list of required auxiliary goods for each area.

### Step 5:

The server queries a storage device or inventory management database to check available stock for each auxiliary good. The input is the goods list from Step 4 and data access credentials for the inventory database. The server sends queries to retrieve stock levels and compares requirements against availability. The output is a discrepancy report stating shortages or surpluses for each good and area.

### Step 6:

The server generates transport and delivery instructions and sends these to the transport management device. The input is the discrepancy report from Step 5. The server creates a delivery schedule including item, quantity, source, destination, and preferred delivery time, and transmits the instruction using a standard API. The output is a confirmation of task receipt from the transport management device and an updated delivery plan.

### Step 7:

The user, such as an evacuation area administrator, inputs real-time site information using a user terminal (e.g., a smartphone or tablet application). The input is the current on-site number of evacuees and the observed inventory of goods, entered through form fields or selector buttons in the terminal app. The user presses submit, and the output is the transmission of this site report to the server in a structured data format.

### Step 8:

The server receives the field report from the user terminal and updates the internal database. The input is the on-site report from Step 7, containing recent values for evacuee count and goods status. The server overwrites previous database entries with the new values and triggers automatic recalculation of supply requirements if significant changes are detected. The output is an updated database reflecting the current status of each evacuation area and, if recalculation is triggered, a new delivery instruction as output.

### Step 9:

The user, either an administrator or an evacuee, records multimodal emotional state data using the user terminal. The input consists of captured facial images, voice recordings, or entered text reflecting the user's emotional status. The terminal collects the data files and uploads them to the emotion estimation device via the server. The output is the successful receipt of these multimedia files by the emotion estimation device for analysis.

### Step 10:

The emotion estimation device analyzes the multimodal emotional state data to determine the emotional condition of the users. The input includes the uploaded multimedia files captured in Step 9. The device runs emotion recognition models (such as facial expression or sentiment analysis algorithms) and outputs a report with emotion classification results, such as the percentage of users detected with high stress or anxiety.

### Step 11:

The server reviews the emotional state analysis results and, if necessary, triggers psychological support measures or special goods instructions. The input is the emotional assessment report from Step 10. The server applies decision logic to determine whether additional counselors or stress-relief goods are needed, then generates and issues supplementary delivery or support orders. The output is the issuance of new psychological support instructions and updates to the delivery plan, as well as the logging of these actions in the system.

### Step 12:

The server generates an information input sentence or prompt for a generative AI model if advanced scenario simulation or reporting is required. The input is the current comprehensive status of the system, and the server composes a prompt text reflecting the situation. The output is a textual prompt, such as:

“Please simulate the operation of this emergency shelter management system, including the flow of real-time population data collection, AI-driven prediction of needed supplies, logistics planning, and emotional data analysis. Show step-by-step server- and terminal-side processing and concrete outputs.”

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In the management of disaster shelters, it is critically important to swiftly and accurately comprehend the situation of evacuees and supply the appropriate support materials. However, conventional systems face difficulties in collecting and utilizing real-time data on communication network status, population movement, and on-site conditions, especially immediately following a disaster. Furthermore, these systems do not adequately address the psychological state of evacuees, nor do they effectively provide psychological support or maintain security within the shelter. As a result, there are significant challenges in ensuring the efficient supply of materials, delivering mental care tailored to current emotional states, and securing shelter safety.

The specific processing by the specific processing unit 290 of the data processing device 12 in Application Example 2 is realized by the following means.

The present invention provides a server including functions to collect pre-disaster information on communication networks and population movement, preprocess and analyze such data using a trained generative artificial intelligence model to estimate the number of occupants in each shelter, calculate and manage the preparation and transportation of support materials, dynamically update required quantities upon receiving new on-site information after communication recovery, perform emotion recognition from multimedia data to prompt psychological support or special supply instructions, and execute automated security monitoring and alerts by analyzing video streams from monitoring devices. This enables comprehensive shelter management, combining efficient material supply, real-time data updating, psychological care for evacuees, and enhanced security within disaster shelters.

The term “processor” refers to an information processing apparatus or device capable of executing instructions and performing data processing tasks necessary for the operation of the system.

The term “communication network” refers to any infrastructure or system that facilitates data transmission among multiple devices, including but not limited to wired or wireless telecommunication systems and internet networks.

The term “first information” refers to data collected before the occurrence of a disaster, including the status of communication networks and information relating to the movement or distribution of persons.

The term “external information sources” refers to any devices, servers, or systems outside the present system which provide data such as communication network status, demographic movement, or environmental conditions.

The term “data preprocessing apparatus” refers to hardware or software functions equipped to receive, organize, correct, and normalize raw data prior to analysis by artificial intelligence models.

The term “generative artificial intelligence model” refers to a machine learning model, including neural networks, trained using historical data and capable of producing estimations or predictions such as occupant numbers in disaster shelters.

The term “support materials” refers to various physical goods and articles required for the sustenance, health, comfort, and psychological well-being of evacuees, including but not limited to beverages, foods, pharmaceuticals, bedding, recreational items, and hygiene products.

The term “material management apparatus” refers to a device or software system designed to monitor, record, and control inventories and distribution of support materials.

The term “transportation management apparatus” refers to a device or software system configured to plan, schedule, and coordinate the physical distribution and delivery of support materials.

The term “remote terminals” refers to user-operated devices, including but not limited to mobile devices, tablet computers, or desktop computers, capable of collecting and transmitting data relating to on-site shelter conditions.

The term “emotion recognition apparatus” refers to hardware or software configured to analyze video, audio, and/or text data and determine the emotional state of individuals or groups.

The term “psychological support measures” refers to any actions, services, or resource provisions aimed at promoting the mental health and emotional stability of evacuees during a disaster.

The term “monitoring devices” refers to electronic devices, such as cameras or sensors, configured to collect visual or other environmental data from within a shelter facility.

The term “alert information” refers to notifications, warnings, or signals generated by the system indicating the presence of safety, security, or behavioral concerns requiring human attention.

The term “shelter facility” refers to any type of secured location designated to accommodate, protect, and support persons displaced or evacuated in response to a disaster. One embodiment for implementing the present invention is described below.

A server is provided with a processor, a memory, and network communication modules (for example, standard server hardware running a Linux-based operating system). The server is configured to collect data relating to communication network status and population movement from external data providers, such as telecommunications systems or demographic data centers. The data collection is performed via standard network communication protocols such as RESTful APIs. The server uses software libraries such as Requests for Python to request and receive this data in real time. Networked databases, such as PostgreSQL, are used to store the collected data efficiently.

The server preprocesses the collected raw data using data processing modules implemented in Python. Missing values are imputed, and normalization is performed using libraries such as pandas and scikit-learn's MinMaxScaler. The normalized dataset is provided as input to a trained generative AI model for inference. The generative AI model is implemented using frameworks such as TensorFlow or Keras. The model has been previously trained using historical disaster data relevant to evacuee estimation.

Once the AI model predicts the number of occupants at each shelter facility, the server calculates the required types and quantities of support materials. These materials may include beverages, foods, pharmaceuticals, bedding, recreational items, and hygiene products. For inventory management, the server interacts with a material management system and a transportation management system (such as cloud-based inventory and logistics services) via APIs to verify current stock levels and generate dispatch instructions for necessary support materials.

Terminals, such as tablets or smartphones operated by shelter staff, are used to input real-time on-site data (for example, occupant counts and material shortages) and send this updated information to the server. The terminals may be implemented using platforms such as Android or iOS and are connected to the server through secure web APIs.

After communication infrastructure is restored, the server dynamically updates its database using new information received from on-site terminals, recalculates the requirements for support materials, and issues further transportation instructions where shortages are detected.

Additionally, the system is equipped with emotion recognition functionality. The terminals are used to capture, record, and transmit multimedia data such as video, audio, or textual feedback from users at the shelter. This information is sent to an emotion recognition module on the server, which may leverage software such as OpenCV, DeepFace, or cloud-based emotion analysis APIs to determine the emotional state of individuals or groups. Based on the results, the server issues psychological support instructions or arranges special material supplies (e.g., recreational items or counseling).

Furthermore, monitoring devices such as cameras within the shelter facility stream video to the server. The server processes these video streams using object detection and facial recognition software (for example, YOLO or FaceNet). When a potential security risk or an unauthorized individual is detected, the server generates alert information and notifies relevant personnel.

Example prompt sentences used with the generative AI model or emotion recognition engine may include:

“Analyze the latest communication network and population movement data to estimate the number of occupants at Shelter A.”

“Calculate resupply needs for a shelter with 600 people, considering current shortages in food and water.”

“Analyze the uploaded video from Shelter B and report how many individuals appear stressed, calm, or in need of psychological intervention.”

The server, terminals, and users interact through securely managed digital communication, enabling real-time, comprehensive, and data-driven shelter management during disaster scenarios. The architecture supports robust operation through modular and scalable software design, and the use of standard hardware and software components allows practical implementation and adoption.

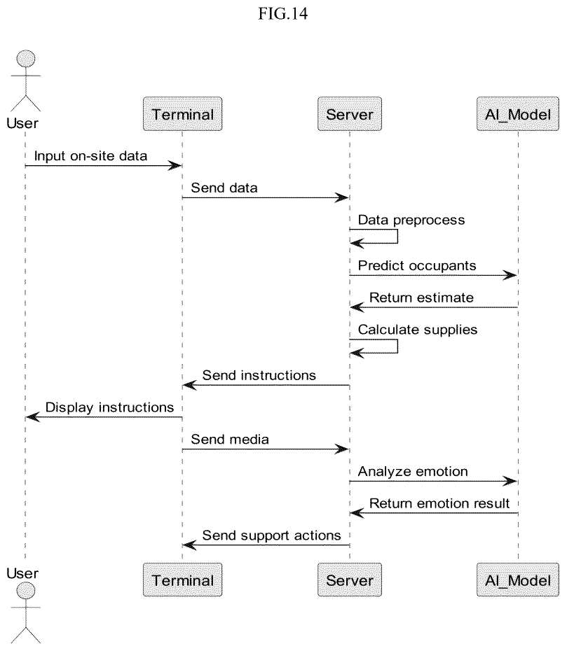

The following describes the processing flow using FIG. 14.

### Step 1:

Server collects external data including communication network status and population movement information by sending API requests to external information sources. As input, the server uses predefined API endpoint URLs. The server receives JSON responses as output, which is then stored in a database. In this step, the server manages network communication, schedules data retrieval, and logs received data for later processing.

### Step 2:

Server preprocesses the collected raw data. The input is the raw data stored in the database. The server cleans the data using data processing tools, fills missing values with historical averages, normalizes the data with MinMaxScaler from scikit-learn, and outputs a normalized dataset. This step prepares the data for AI-based analysis.

### Step 3:

Server inputs preprocessed, normalized data into a generative AI model implemented with TensorFlow or Keras. The input for this step is the normalized dataset. The AI model performs inference and outputs an estimated number of occupants for each shelter facility. The server receives and logs these estimation results.

### Step 4:

Server calculates the required types and quantities of support materials using predefined calculation rules (e.g., 1 liter water per person per day). The input consists of the estimated occupant numbers and the current stock data retrieved from a material management system database. The server outputs a detailed list of supply requirements for each shelter, categorized by material type and quantity.

### Step 5:

Server generates a transportation schedule and issues dispatch instructions. The input is the calculated supply requirements and logistical information such as storage locations and available transport. The server interacts with the transportation management system via API, and the output is a dispatch order containing destination, material details, and delivery schedule. This order is sent to logistics providers.

### Step 6:

Terminal, operated by the shelter administrator, is used to input up-to-date shelter information such as current occupant count and supply shortages. The input is manually entered data through the terminal interface. The terminal submits these details to the server as a structured report. The output is updated status data sent to the server for processing.

### Step 7:

Server receives updated on-site data from terminals and updates the shelter database accordingly. The input is status reports from multiple terminals. The server integrates new information, identifies changes in supply and occupancy, and updates the internal database. The output is a refreshed dataset reflecting the shelter's current situation.

### Step 8:

Server compares updated data with previous estimations, recalculates any changes in support material requirements, and triggers new or additional dispatch instructions if needed. The input is the refreshed shelter dataset from Step 7. The server conducts delta analysis and supply calculations, then outputs new transportation instructions, which are sent to logistics partners or material managers.

### Step 9:

Terminal captures and submits multimedia data, such as video, audio, or text reports, from shelter staff or evacuees. The input is digital media recorded by the terminal device. The output is the multimedia file uploaded to the server or an emotion recognition module.

### Step 10:

Server or an emotion recognition module performs analysis on incoming multimedia data to detect emotional states using tools such as OpenCV or DeepFace. The input is the submitted multimedia file. The server analyzes facial expressions, speech, and text, and the output is an emotional status report. For example, it may indicate the number of stressed or calm individuals.

### Step 11:

Server, based on emotional status reports, generates and issues instructions for psychological support or special material aid. The input is the emotion recognition result associated with each shelter. The output consists of instructions, such as dispatching a counselor or sending recreational items, sent to relevant staff or external suppliers.

### Step 12:

Server monitors security by processing live video streams from shelter monitoring devices using object detection and facial recognition software. The input is real-time video feeds. The server detects unusual behavior or unauthorized entry and outputs alerts containing detected issues and recommendations, which are sent to shelter staff or security personnel.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

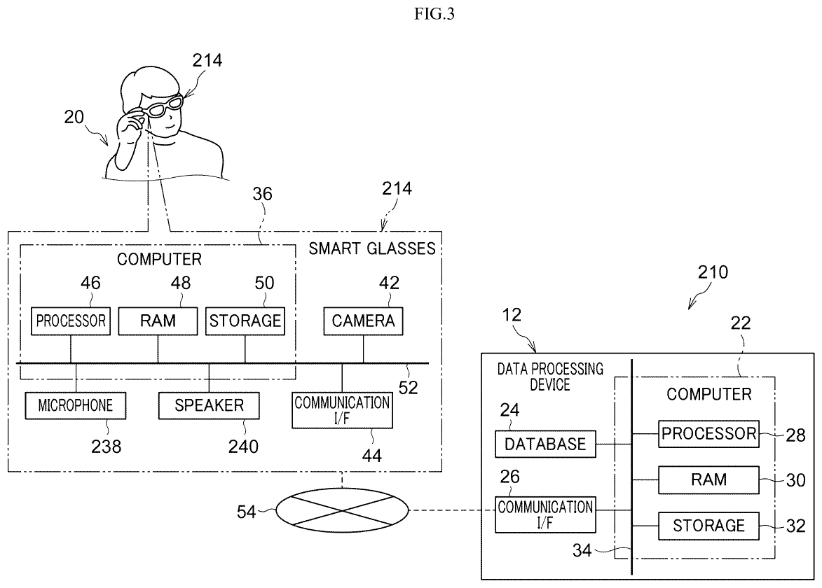

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

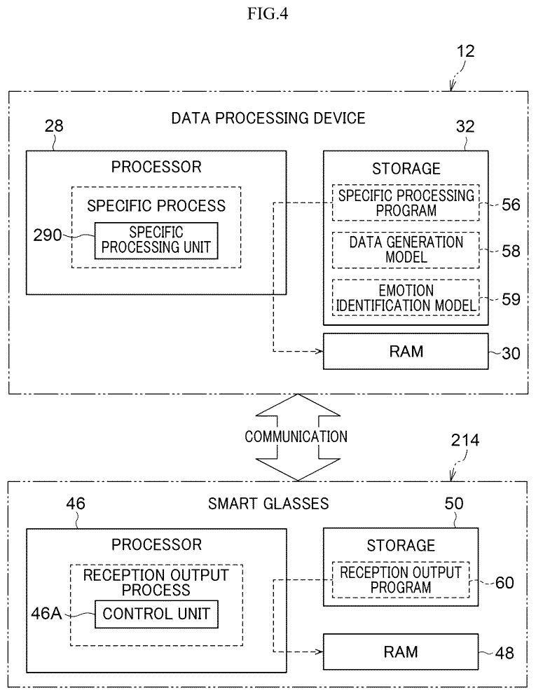

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

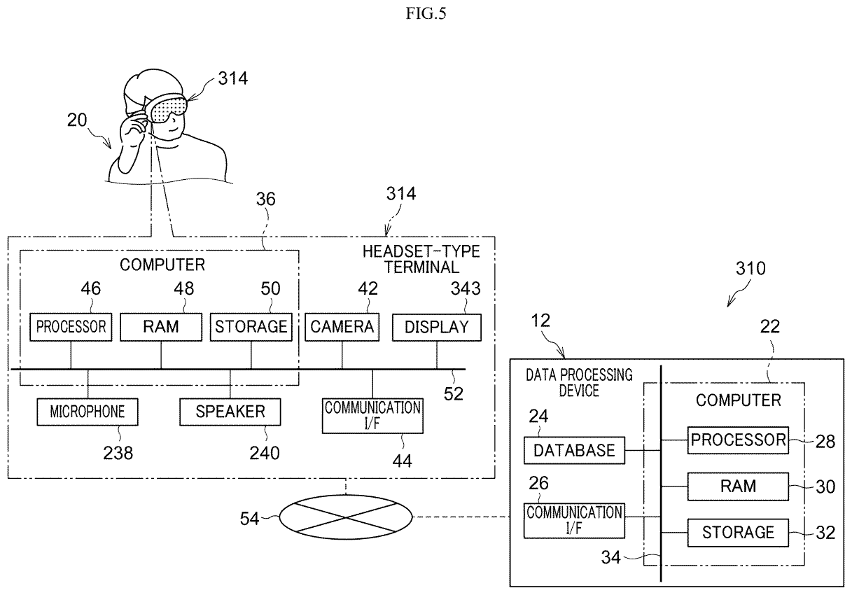

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

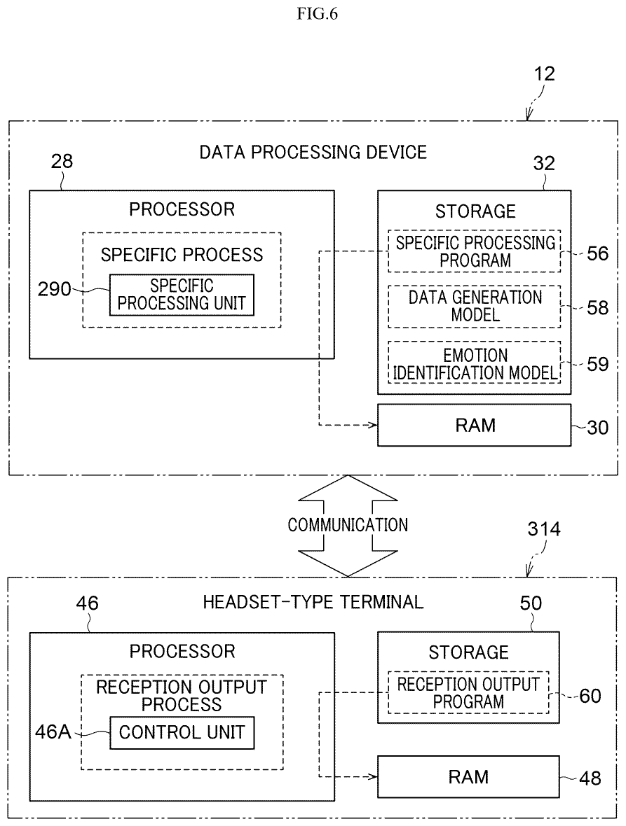

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

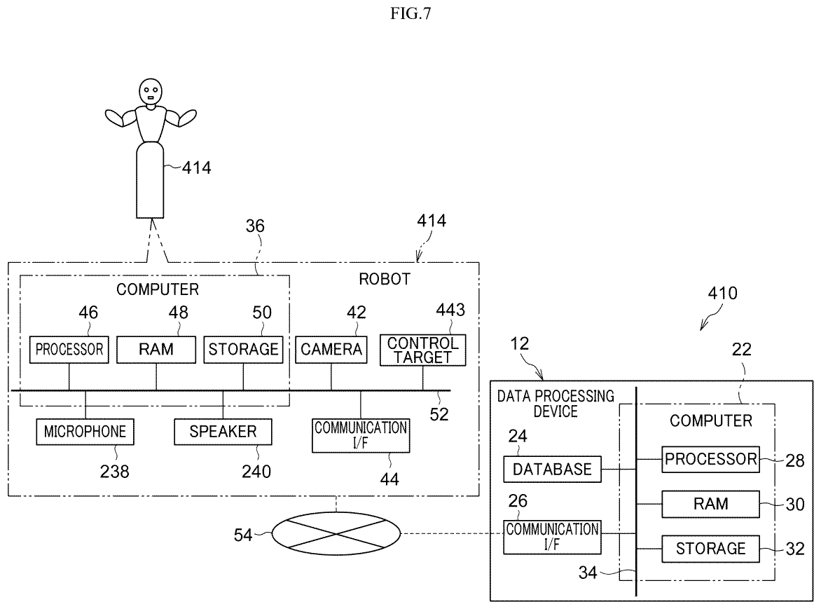

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

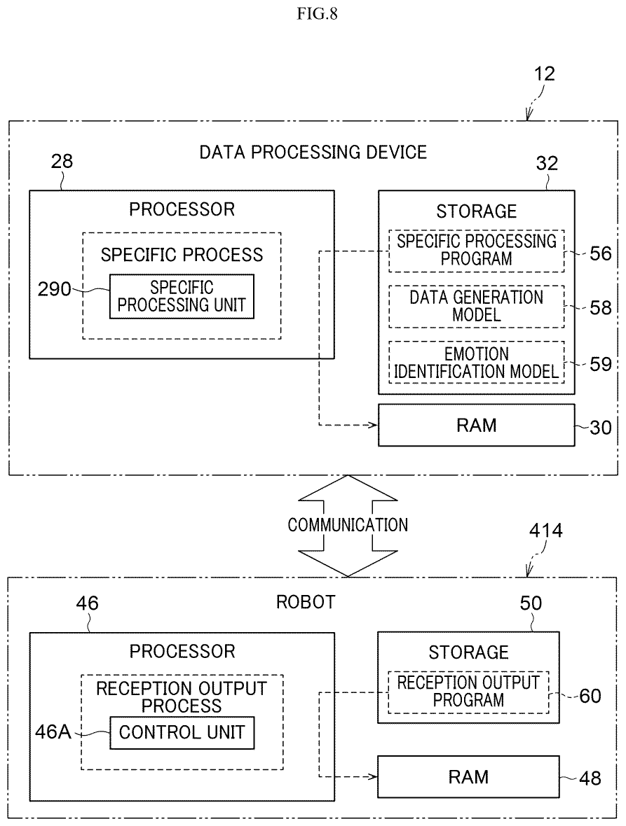

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

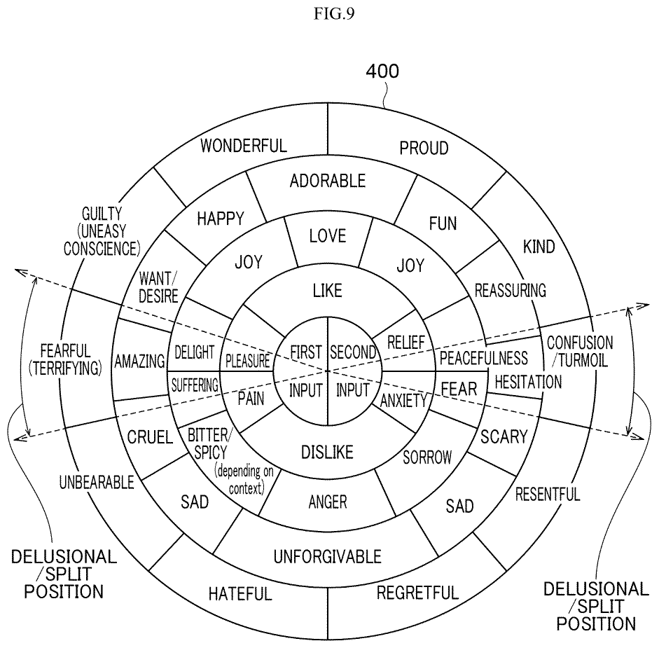

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

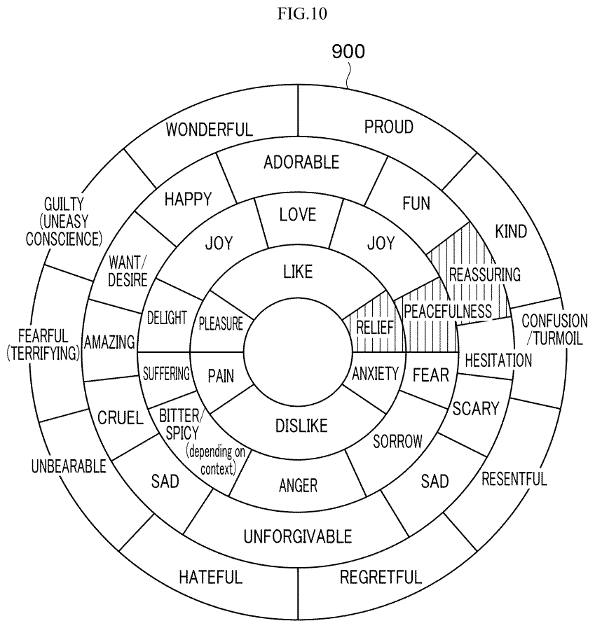

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
acquire mobile entity information and communication state information from a plurality of information providing devices,
perform statistical computation on the acquired data and standardize the data for input into a generative artificial intelligence model,
construct a prompt sentence for the generative artificial intelligence model, and use the input data and predetermined parameters to predict the number of evacuees for each evacuation site,
calculate required quantities of support goods based on the prediction results, confirm stock status in cooperation with a support goods information storage device, and automatically generate and instruct a delivery plan in conjunction with a logistics information processing device,
receive current situation data of evacuation sites input via on-site devices, update the contents of the information storage device, recalculate necessary support goods and delivery information using the generative artificial intelligence model and calculation means, and instruct additional delivery.

### (Supplementary 2)

The system according to supplementary 1,
wherein the processor is configured to cause the generative artificial intelligence model to be trained with past disaster information.

### (Supplementary 3)

The system according to supplementary 1,
wherein the processor is configured to calculate required quantities for support goods belonging to a plurality of categories including liquid necessities, food items, pharmaceuticals, and bedding.

### Application Example 1

### (Supplementary 1)

A system including a processor,
wherein the processor is configured to
collect demographic trend information including time-series data and communication infrastructure information from an external information providing device electronically;
preprocess the collected data for statistical use and execute inference by a generative information processing device based on the processed data to estimate the number of users of evacuation facilities;
automatically calculate a required amount of livelihood support materials based on the estimated number of users, reference inventory information, optimize transportation plans, and electronically transmit delivery instructions to a transportation entity;
receive situational information input from a field management input device, update an information storage device, and execute automatic calculation of additional livelihood support materials and delivery instructions based on the updated information;
estimate an emotional state of the evacuation facility users by an emotional identification information processing device and automatically execute psychological support measures or delivery instructions for entertainment materials according to the emotional state;
and notify a user of response status and information update status via a management input device.

### (Supplementary 2)

The system according to supplementary 1,
wherein the processor is configured to
dynamically optimize an inference algorithm of the generative information processing device by learning from multiple sets of disaster time-series data.

### (Supplementary 3)

The system according to supplementary 1,
wherein the processor is configured to
include potable water, consumable food, health maintenance goods, sleeping support goods, and consumable welfare aid goods in the calculated amount of livelihood support materials.

### Example 2

### (Supplementary 1)

A system including a processor,
wherein the processor is configured to
acquire communication environment information and population dynamics information from a communication network management device or information processing device,
normalize and complete missing data in the acquired information,
input the normalized and completed information into a computational intelligence model implemented by a calculation learning device or machine learning device, and derive estimated personnel values for each evacuation area,
calculate the quantity of auxiliary goods necessary for minimum livelihood maintenance based on the estimated personnel values, and issue instructions for preparation and delivery to a storage device for auxiliary goods and a transport management device,
receive on-site information and possession information from an evacuation area administrator through a user terminal, update a storage device with such information, and recalculate the quantity of auxiliary goods and issue additional delivery instructions as needed,
collect at least one of expression data, sound data, or character data using the user terminal and transmit it to an emotion estimation device,
issue psychological support measures and special goods supply instructions based on emotional state data analyzed by the emotion estimation device,
and output an information input sentence specifying a content to be presented to a generative intelligence model.

### (Supplementary 2)

The system according to supplementary 1,
wherein the processor is configured to
utilize a computational intelligence model that has been trained based on past disaster-related information.

### (Supplementary 3)

The system according to supplementary 1,
wherein the processor is configured to
calculate the quantity of auxiliary goods for items including drinking liquids, nutritional foods, health maintenance drugs, bedding, and recreational items.

### Application Example 2

### (Supplementary 1)

A system including a processor,
wherein the processor is configured to
collect, via a communication path from external information sources, first information including a state of a communication network prior to a disaster occurrence and information relating to movement of persons,
preprocess and normalize the first information using a data preprocessing apparatus, and provide the preprocessed information as input to a trained generative artificial intelligence model to estimate a number of occupants for each shelter facility,
calculate types and quantities of support materials based on the estimation result, and coordinate with a material management apparatus and a transportation management apparatus to generate and issue preparation and transportation instructions,
after communication is restored, receive updated information regarding current conditions of shelter facilities, including number of occupants and remaining materials, from remote terminals, update an existing database with the received information, recalculate necessary types and quantities of additional support materials, and issue instructions for additional transportation,
collect video information, audio information, and text information through on-site computing devices or mobile terminals, analyze emotional states of multiple persons by an emotion recognition apparatus, and based on the analysis result, issue instructions to implement psychological support measures or special support material supply,
execute automatic recognition processing on video information acquired from monitoring devices, and issue alert information for the purpose of maintaining order or ensuring safety within the facility.

### (Supplementary 2)

The system according to supplementary 1,
wherein the processor is configured to utilize an algorithm for the generative artificial intelligence model that is trained using historical disaster information datasets.

### (Supplementary 3)

The system according to supplementary 1,
wherein the processor is configured to treat support materials as including a plurality of types of articles such as beverages, foods, pharmaceuticals, bedding, recreational items, and hygiene products.

What is claimed is:

1. A system comprising a processor that is configured to:
collect pre-disaster communication environment data and mobile population data;
estimate the number of evacuees at each evacuation shelter by using an artificial intelligence model based on the collected data;
calculate the amount of needed relief supplies based on the estimation result, to instruct preparation and delivery of the supplies; and
after communication recovery, collect on-site situation data, update the data, recalculate the required supplies, and instruct additional delivery of supplies.

2. The system according to claim 1, wherein the artificial intelligence model is trained using past disaster data.

3. The system according to claim 1, wherein the processor calculates the amount of needed relief supplies including specific relief items such as water, food, medicine, and blankets.
